(19) United States
(12) Patent Application Publication
(10) Pub. No.: US 2026/0128335 A1
(43) Pub. Date: May 7, 2026

(54) SOLID OXIDE FUEL CELL SYSTEM WITH HEATING AND COOLING FUNCTIONS

(71) Applicant: Hoon Yang PARK, Seongnam-si (KR)

(72) Inventor: Hoon Yang PARK, Seongnam-si (KR)

(21) Appl. No.: 19/380,934

(22) Filed: Nov. 5, 2025

(30) Foreign Application Priority Data
Nov. 6, 2024 (KR) 10-2024-0156040

(51) Int. Cl. H01M 8/04746; H01M 8/04007; H01M 8/04014; H01M 8/04029; H01M 8/04291; H01M 8/0432; H01M 8/0612; H01M 8/1007

(52) U.S. Cl. CPC H01M 8/04753; H01M 8/04022; H01M 8/04029; H01M 8/04067; H01M 8/04291; H01M 8/04373; H01M 8/04776; H01M 8/0618; H01M 8/1007

(57) ABSTRACT

Proposed is a solid oxide fuel cell system including a reformer configured to react fuel gas with air to generate reformed gas containing hydrogen, a fuel cell stack configured to produce electricity by reacting the reformed gas with the air, a water supply part configured to supply water, a first circulation line configured to circulate water supplied from the water supply part, a fuel electrode discharge line configured to discharge unreacted excess reformed gas from the fuel cell stack, and a first heater provided in the first circulation line and configured to heat the water via heat exchange with the excess reformed gas to increase temperature of the water.

### CROSS REFERENCE TO RELATED APPLICATION

The present application claims priority to Korean Patent Application No. 10-2024-0156040, filed Nov. 6, 2024, the entire contents of which is incorporated herein for all purposes by this reference.

### BACKGROUND

### Technical Field

The present disclosure relates to a solid oxide fuel cell system and, more particularly, to a solid oxide fuel cell system that generates electricity by reacting a fuel gas with air.

### Description of the Related Art

Fuel cells are electrochemical devices that convert the chemical energy of hydrogen and oxygen into electrical energy.

Depending on their operating temperature and primary fuel type, fuel cells can be classified into alkaline fuel cells (AFCs), phosphoric acid fuel cells (PAFCs), molten carbonate fuel cells (MCFCs), solid oxide fuel cells (SOFCs), and polymer electrolyte membrane fuel cells (PEMFCs).

Alkaline fuel cells and polymer electrolyte fuel cells operate at temperatures from room temperature to below 100° C., while phosphoric acid fuel cells operate at around 150° C. to 200° C. Molten carbonate fuel cells and solid oxide fuel cells are classified as high-temperature fuel cells, operating at temperatures ranging from approximately 600° C. to 1,000° C. For these high-temperature fuel cells to be operated on ships, they need to be maintained at elevated temperatures.

In this case, a solid oxide fuel cell (SOFC) is a type of fuel cell that uses a solid oxide material, which is permeable to oxygen ions, as its electrolyte. It converts a fuel (e.g., hydrogen, methane, natural gas, etc.) and an oxidant (e.g., air) into electricity and heat through an electrochemical reaction. An SOFC typically consists of an anode (fuel electrode), a cathode (air electrode), and a solid electrolyte positioned therebetween. At the anode, the fuel is oxidized, while at the cathode, oxygen from air is reduced.

Because solid oxide fuel cells use solid-state electrolytes, there is relatively little electrolyte loss or corrosion, which can improve long-term stability and durability.

Solid oxide fuel cells facilitate fuel utilization through internal reforming, and their high-temperature exhaust gases enable cogeneration by using waste heat.

However, conventional solid oxide fuel cells utilize expensive catalysts, such as reforming and combustion catalysts, which increase costs. Moreover, a high catalyst thermal mass can delay the attainment of the operating temperature during initial startup.

In this case, a reforming catalyst is a catalyst used in the fuel reforming process. Solid oxide fuel cells (SOFCs) can reform fossil fuels (e.g., natural gas, methanol) at high temperatures to produce hydrogen using such a catalyst. This process generates hydrogen as well as other gases, such as carbon monoxide and carbon dioxide. A combustion catalyst promotes combustion reactions and can be used to oxidize unburned fuel in solid oxide fuel cells when the fuel is not completely combusted.

In conventional solid oxide fuel cells, if the unreacted excess reformed gas and excess air in the fuel cell stack are not utilized and are burned and then discharged to the outside, the efficiency of the solid oxide fuel cell system may be reduced.

### SUMMARY

Accordingly, the present disclosure has been made keeping in mind the above problems occurring in the related art, and the present disclosure is intended to provide a solid oxide fuel cell system that utilizes unreacted excess reformed gas and excess air from a fuel cell stack to produce hot water.

In addition, an objective of the present disclosure is to provide a solid oxide fuel cell system with heating and cooling functions. The system improves efficiency and performance by combusting fuel gas and air by a burner, heating the inside of a reformer to a set temperature corresponding to the operating conditions of the reformer by the heat generated during combustion (heat of combustion), and using the air heated by the reformer's internal heat to heat the fuel cell stack to a set temperature corresponding to the operating conditions of the fuel cell stack.

In order to achieve the above objectives, according to an aspect of the present disclosure, there is provided a solid oxide fuel cell system including: a reformer configured to react fuel gas with air to generate reformed gas containing hydrogen; a fuel cell stack configured to produce electricity by reacting the reformed gas with the air; a water supply part configured to supply water; a first circulation line configured to circulate water supplied from the water supply part; a fuel electrode discharge line configured to discharge unreacted excess reformed gas from the fuel cell stack; and a first heater provided in the first circulation line and configured to heat the water via heat exchange with the excess reformed gas to increase temperature of the water.

The system may further include: an air electrode discharge line configured to discharge unreacted excess air from the fuel cell stack; and a combustor connected to the fuel electrode discharge line and the air electrode discharge line, wherein the combustor may burn the mixture of excess reformed gas and excess air discharged through the fuel electrode discharge line and the air electrode discharge line, and may discharge the resulting combustion gases to the outside.

The system may further include: a fuel electrode supply line configured to connect the reformer and a fuel electrode of the fuel cell stack and supply the reformed gas to the fuel electrode; a second heater provided in the first circulation line, and configured to heat the water and then send the heated water to the first heater; a third branch line branched from the fuel electrode supply line and configured to connect the second heater and the combustor; a third directional valve provided at a branch point of the fuel electrode supply line; a sensor part configured to detect at least one of a component and temperature of the reformed gas; and a controller configured to control a flow path by means of the third directional valve to send the reformed gas to the second heater through the third branch line so that the reformed gas exchanges heat with the water, and send the heat-exchanged reformed gas to the combustor for combustion, when at least one of the component and temperature of the reformed gas detected by the sensor part does not meet supply conditions for the fuel cell stack.

The system may further include: a second circulation line configured to circulate water supplied from the water supply part; and a third heater provided in the second circulation line and configured to heat the water via heat exchange with heat generated during combustion in the combustor.

The system may further include: a fuel gas supply part configured to supply fuel gas; an air supply part configured to supply air; and a burner configured to heat the inside of the reformer to a set temperature corresponding to the operating conditions of the reformer.

The system may further include: a first heat exchanger that receives air from the air supply part and heat the received air via heat exchange with the internal heat of the reformer when the inside of the reformer reaches to the set temperature corresponding to the operating conditions of the reformer by the burner; an air electrode supply line that connects the first heat exchanger and the air electrode of the fuel cell stack, and supplies the air heated in the first heat exchanger to the air electrode of the fuel cell stack, wherein the fuel cell stack may be operated when the set temperature corresponding to the operating conditions is reached by the heated air supplied from the first heat exchanger.

The system may further include: a filtering part that filters the reformed gas supplied from the reformer to remove impurities; and a second heat exchanger that performs heat exchange between the reformed gas filtered by the filtering part and the air heated by the first heat exchanger, wherein the reformed gas heat-exchanged by the second heat exchanger may be supplied to the fuel electrode of the fuel cell stack, and the air heat-exchanged by the second heat exchanger may be supplied to the air electrode of the fuel cell stack.

According to the solid oxide fuel cell system of the present disclosure, the following effects are achieved.

First, the internal temperature of the reformer can be increased to suit operating conditions by combusting fuel gas and air.

Second, the heat within the reformer can be used to heat the air, and the heated air can then be used to raise the temperature of the fuel cell stack to suit operating conditions.

Third, it is possible to prevent performance degradation and abnormal operation of the fuel cell stack by detecting a case where at least one of the component and temperature of the reformed gas does not meet the supply conditions for the fuel cell stack.

Fourth, hot water can be produced by utilizing heat generated from the combustion of the unreacted excess reformed gas and excess air discharged from the fuel cell stack.

Fifth, unreacted excess reformed gas in the fuel cell stack, as well as reformed gas that does not meet the supply conditions for the stack, can be utilized to produce hot water.

The effects of the present disclosure are not limited to the ones mentioned above, and other effects not mentioned will be clearly understood by those skilled in the art from the description of the claims.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 shows a solid oxide fuel cell system according to an embodiment;

FIG. 2 is a block diagram showing the control-related configuration of the solid oxide fuel cell system of FIG. 1;

FIG. 3 shows another example of a configuration for heating water using unreacted excess reformed gas from a fuel cell stack and reformed gas that does not meet the supply conditions for the fuel cell stack in the solid oxide fuel cell system of FIG. 1;

FIG. 4 shows still another example of a configuration for heating water using unreacted excess reformed gas and excess air from a fuel cell stack and heat generated from the combustion of reformed gas that does not meet the supply conditions for the fuel cell stack in the solid oxide fuel cell system of FIG. 1;

FIG. 5 is a flowchart showing the operation method of the solid oxide fuel cell system of FIG. 1; and

FIG. 6 shows still another example of a configuration in which a water branch line is provided separately in the solid oxide fuel cell system of FIG. 1.

### DETAILED DESCRIPTION

Advantages and features of the present disclosure, and methods for achieving them, will become clear by referring to embodiments described in detail below along with the accompanying drawings. However, the present disclosure is not limited to the embodiments disclosed below and may be implemented in various different forms. These embodiments are provided solely to ensure that the disclosure of the present disclosure is complete and to fully inform those skilled in the art of the present disclosure of the scope of the invention, and the present disclosure is only defined by the scope of the claims. Like reference numerals refer to like elements throughout the specification.

The sizes and shapes of components shown in the drawings attached to this specification may be exaggerated for clarity and convenience of explanation. It should be noted that the same component may be indicated by the same reference numeral in each drawing. In addition, detailed descriptions of the function and configuration of the disclosed technology that are judged to unnecessarily obscure the gist of the present disclosure may be omitted.

Terms used herein are used to describe specific embodiments and are not intended to limit the present disclosure. As used herein, singular forms include plural forms unless the context clearly indicates otherwise. In addition, throughout this specification, when a part “includes” a certain element, this means that the part may further include other elements unless specifically stated to the contrary.

When a component is described to be “connected” or “joined” to another component, it is understood that the component may be directly connected to or joined to that another component, but still another component may be present therebetween. On the other hand, when a component is described to be “directly connected” or “directly joined” to another component, it should be understood that there are no component therebetween. Other expressions to describe relationships between components should be interpreted in the same manner.

Terms such as an upper end, a lower end, upper surface, lower surface, an upper part, and a lower part, etc. used in this specification are used to distinguish the relative positions of components. For example, for convenience, when the upper side of the drawing is called an upper part and the lower side of the drawing is called a lower part, in reality, the upper part may be named a lower part, and the lower part may be named an upper part, without exceeding the scope of the rights of the present disclosure.

Terms including ordinal numbers, such as “first” and “second”, etc., described in this specification may be used to describe various components, but the components are not limited by the terms. The terms are only used to distinguish each component from another, and are not limited by a manufacturing order, and names thereof may not match in the detailed description and claims of the present disclosure.

All terms, including technical or scientific terms, used in this specification, unless otherwise defined, have the same meanings as commonly understood by those skilled in the art to which the present disclosure pertains. Terms defined in commonly used dictionaries should be interpreted as having meanings consistent with the meanings in the context of the related technology, and unless clearly defined in this specification, should not be interpreted in an idealized or overly formal sense.

The reference numerals attached to individual steps are used to identify individual steps and do not indicate the order of the steps, and the steps may be performed in a different order than stated unless the context clearly indicates a specific order.

Hereinafter, the present disclosure will be described with reference to the attached drawings.

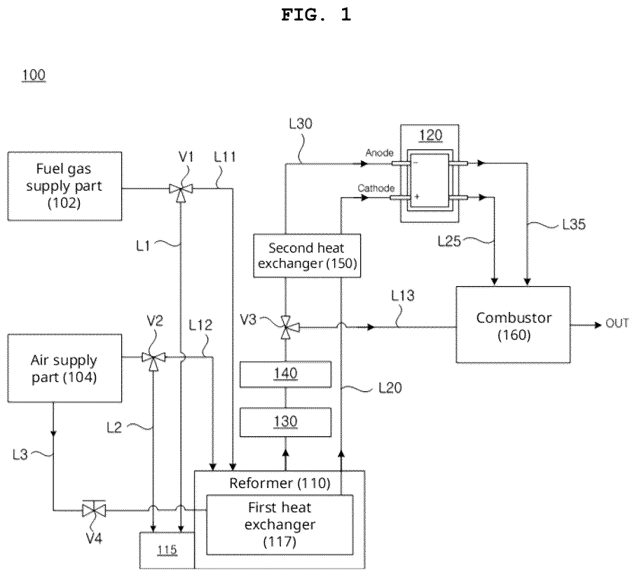

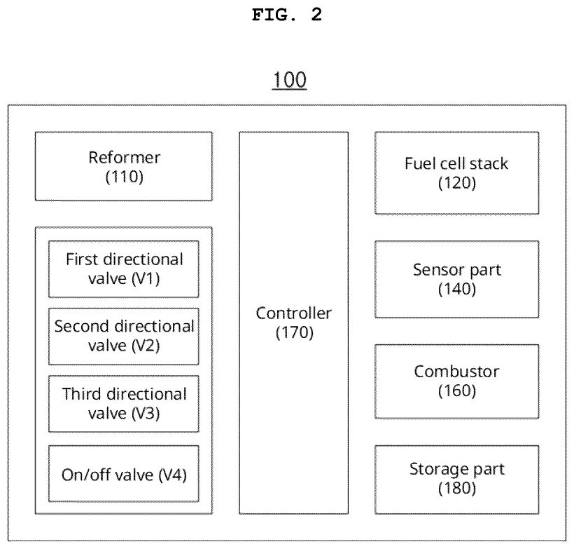

FIG. 1 shows a solid oxide fuel cell system according to an embodiment, and FIG. 2 is a block diagram showing the control-related configuration of the solid oxide fuel cell system of FIG. 1.

Referring to FIGS. 1 and 2, a solid oxide fuel cell system 100 according to an embodiment of the present disclosure includes a fuel gas supply part 102, an air supply part 104, a reformer 110, a fuel cell stack 120, a filtering part 130, a sensor part 140, a second heat exchanger 150, a combustor 160, a controller 170, and a storage part 180. The solid oxide fuel cell system 100 may be applied to, for example, a solid oxide fuel cell for ships.

The fuel gas supply part 102 supplies fuel gas to the reformer 110. The fuel gas may include, for example, one or more of natural gas, liquefied petroleum gas (LPG), liquefied natural gas (LNG), biogas, methanol, and propane. The fuel gas is not limited thereto and may include a variety of hydrocarbon-based fuels.

The air supply part 104 supplies air to the reformer 110. Although not shown, the air supply part 104 may include one or more of an air compressor and a blower.

The air supply part 104 may use an air compressor to suck in external air, compress the sucked in air, and supply the compressed air to the reformer 110. A blower performs a similar function to an air compressor, but may supply air at a relatively low pressure. A blower may continuously supply air at a constant speed.

The reformer 110 receives fuel gas and air and generates reformed gas containing hydrogen.

The reformer 110 may include a burner 115 and a first heat exchanger 117.

The reformer 110 may be operated to generate reformed gas when the inside of the reformer 110 reaches a set temperature corresponding to the operating conditions by the burner 115.

The solid oxide fuel cell system 100 includes: a first supply line L1 connecting the fuel gas supply part 102 and the burner 115; and a second supply line L2 connecting the air supply part 104 and the burner 115.

The solid oxide fuel cell system 100 may include: a first branch line L11 branched from the first supply line L1 and connected to the reformer 110; a second branch line L12 branched from the second supply line L2 and connected to the reformer 110; a first directional valve V1 provided at a branch point of the first supply line L1; and a second directional valve V2 provided at a branch point of the second supply line L2.

The first directional valve V1 and the second directional valve V2 may be three-way valves. A three-way valve controls the flow of fluid through three ports. A three-way valve can allow fluid flow in one direction or divert the fluid flow to another direction under certain circumstances.

The flow paths of fuel gas supplied from the fuel gas supply part 102 and air supplied from the air supply part 104 may be controlled by the first directional valve V1 and the second directional valve V2.

In order to increase the temperature inside the reformer 110, the flow is controlled by the first directional valve V1 and the second directional valve V2, so that fuel gas and air may be supplied to the burner 115 through the first supply line L1 and the second supply line L2, respectively.

The burner 115 burns the fuel gas and air supplied through the first supply line L1 and the second supply line L2, and raises the temperature inside the reformer 110 to a set temperature corresponding to the operating conditions of the reformer 110 by the heat generated during combustion (hereinafter, also referred to as the heat of combustion).

During initial operation of the solid oxide fuel cell system 100, the burner 115 may burn fuel gas and air to quickly raise the temperature of the reformer 110 to a set temperature using the heat of combustion. As a result, the interior of the reformer 110 may quickly reach the appropriate operating conditions, enabling the rapid operation of the solid oxide fuel cell system 100.

The burner 115 may raise the temperature inside the reformer 110 to approximately 750 degrees or more, and when the set temperature is reached, the reformer 110 may switch to flameless reforming mode.

Flameless reforming is a method that induces the required chemical reaction without the presence of a visible flame during the production of reformed gas containing hydrogen, achieved by reacting fuel gas and air within the reformer 110.

To be specific, once the temperature inside the reformer 110 becomes sufficiently high (e.g., 750 degrees or higher), the chemical reaction between fuel gas and air occurs spontaneously without a flame. The reformer 110 maintains the high temperature and proceeds with the reforming reaction in a flameless state after reaching the set temperature using the heat of combustion of the burner 115.

Unlike traditional flame reactions, no localized high-temperature zones are formed in the flameless state, allowing heat to be evenly distributed within the reformer 110. This uniform temperature distribution is beneficial for enhancing reaction efficiency and preventing damage caused by local overheating.

Flameless reforming mode is generally advantageous for reducing harmful emissions, such as nitrogen oxides (NOX). Because no high-temperature flame is generated during the reaction, the formation of harmful substances can be minimized.

Furthermore, flameless reforming mode reduces the risk of flame-induced explosion, allowing for safe operation of the reformer 110.

After the temperature inside the reformer 110 reaches the set temperature corresponding to the operating conditions of the reformer 110, the flow path is controlled by the first directional valve V1 and the second directional valve V2 to generate reformed gas, so that fuel gas and air may be supplied to the reformer 110 through the first branch line L11 and the second branch line L12, respectively.

The first heat exchanger 117 may receive air from the air supply part 104 and heat the air via heat exchange with the internal heat of the reformer 110 after the temperature inside the reformer 110 reaches a set temperature corresponding to the operating conditions of the reformer 110,

The air supply part 104 and the first heat exchanger 117 may be connected by a third supply line L3, and an on-off valve V4 may be provided in the third supply line L3. After the temperature inside the reformer 110 reaches a set temperature corresponding to the operating conditions of the reformer 110, the on-off valve V4 opens so that the air supplied from the air supply part 104 may be supplied to the first heat exchanger 117.

Air heated by the first heat exchanger 117 may be supplied to the fuel cell stack 120 through an air electrode supply line L20.

The fuel cell stack 120 generates electricity by reacting a reformed gas with air.

The fuel cell stack 120 may be operated when the set temperature corresponding to the operating conditions of the stack 120 is reached by the heated air supplied from the first heat exchanger 117.

The fuel cell stack 120 may be implemented as a solid oxide fuel cell (SOFC), in which case the operating temperature may be in the range of 570° C. to 620° C.

The air electrode and fuel electrode of the fuel cell stack 120 are connected to the air electrode supply line L20 and a fuel electrode supply line L30, respectively.

The air electrode supply line L20 connects the first heat exchanger 117 and the air electrode of the fuel cell stack 120, and as described above, receives heated air from the first heat exchanger 117 and supplies the received air to the air electrode of the fuel cell stack 120.

The fuel electrode supply line L30 connects the reformer 110 and the fuel electrode of the fuel cell stack 120, and receives reformed gas from the reformer 110 and supplies the received gas to the fuel electrode of the fuel cell stack 120.

A third branch line L13 branched from the fuel electrode supply line L30 is connected to the combustor 160, and a third directional valve V3 may be provided at the branch point of the fuel electrode supply line L30. The third directional valve V3 may be a three-way valve.

Unreacted excess air in the fuel cell stack 120 may be discharged toward the combustor 160 through an air electrode discharge line L25.

Unreacted excess reformed gas in the fuel cell stack 120 may be discharged toward the combustor 160 through a fuel electrode discharge line L35.

The filtering part 130 may be provided in the fuel electrode supply line L30 and filters the reformed gas supplied from the reformer 110 to remove impurities.

The filtering part 130 may include, for example, a ceramic filter. The ceramic filter features a porous structure that traps solid particles or impurities through tiny pores.

The reformed gas produced by the reformer 110 contains various gas components, including hydrogen, and the gas components may include impurities generated during the reaction process. These impurities may deteriorate the performance of the fuel electrode (anode) and air electrode (cathode) inside the fuel cell stack 120. The filtering part 130 removes impurities from the reformed gas supplied to the fuel cell stack 120, thereby preventing deterioration of the performance of the fuel cell stack 120.

To be specific, the filtering part 130 may remove solid particles, fine dust, catalyst particles, metal oxides, or other reaction by-products contained in the reformed gas.

In addition, the filtering part 130 removes chemical impurities, such as sulfur compounds and halogen compounds, from the reformed gas, which could harm the fuel cell stack 120, ensuring stable operation of the fuel cell stack 120.

As such, the filtering part 130 protects the components and internal structure of the fuel cell stack 120 by removing impurities contained in the reformed gas, thereby extending the lifespan of the fuel cell stack 120 and reducing maintenance costs.

The sensor part 140 may be installed in the fuel electrode supply line L30 and detects at least one of the component and temperature of the reformed gas. The sensor part 140 may detect a case where at least one of the component and temperature of the reformed gas does not meet the supply conditions for the fuel cell stack 120, preventing performance degradation and abnormal operation of the fuel cell stack 120.

To be specific, the sensor part 140 may detect the chemical components of the reformed gas. The reformed gas may contain various gas components such as hydrogen (H2), carbon monoxide (CO), carbon dioxide (CO2), and methane (CH4). The sensor part 140 may detect the concentration of the components present in the reformed gas. Due to this, it can be confirmed whether the reformed gas satisfies the supply conditions required by the fuel cell stack 120. If the concentration of a specific component does not satisfy the supply conditions required by the fuel cell stack 120, the performance of the fuel cell stack 120 may be degraded.

The sensor part 140 may detect the temperature of the reformed gas, thereby confirming whether the temperature of the reformed gas satisfies the supply conditions (570° C. to 620° C.) required by the fuel cell stack 120. If the temperature of the reformed gas does not satisfy the supply conditions required by the fuel cell stack 120, the fuel cell stack 120 may not operate normally.

In case that one or more of the component and temperature of the reformed gas detected by the sensor part 140 do not satisfy the supply conditions required by the fuel cell stack 120, the flow path is controlled by the third directional valve V3 so that the reformed gas is sent to the combustor 160 through the third branch line L13 and combusted.

The second heat exchanger 150 transfers heat between the reformed gas filtered by the filtering part 130 and the air heated by the first heat exchanger 117. When the reformed gas filtered by the filtering part 130 satisfies the supply conditions required by, the reformed gas is supplied to the second heat exchanger 150 through the fuel electrode supply line L30 and undergoes heat exchange with the air supplied through the air electrode supply line L20.

The reformed gas that has exchanged heat with air by the second heat exchanger 150 is supplied to the fuel electrode through the fuel electrode supply line L30, and the air that has exchanged heat with the reformed gas by the second heat exchanger 150 is supplied to the air electrode through the air electrode supply line L20.

The second heat exchanger 150 transfers heat between the reformed gas and air, reducing the temperature difference between the reformed gas and air and allowing the reformed gas and air to be optimized to meet the supply conditions for the fuel cell stack 120.

This improves the performance of the fuel cell stack 120 and enhances energy efficiency.

The second heat exchanger 150 may prevent damage to the fuel cell stack 120 and extend the lifespan thereof by controlling the temperature of the reformed gas and air supplied to the fuel cell stack 120. The second heat exchanger 150 may prevent the fuel cell stack 120 from being degraded or damaged due to excessively hot or cold fluid being supplied to the fuel cell stack 120.

The combustor 160 is connected to the fuel electrode discharge line L35 and the air electrode discharge line L25, and may burn the mixture of excess reformed gas and excess air respectively discharged through the fuel electrode discharge line L35 and the air electrode discharge line L25, and discharge the resulting combustion gases to the outside.

The combustor 160 is connected to the third branch line L13, and may receive the reformed gas that does not meet the supply conditions for the fuel cell stack 120, combust the received gas, and discharge the combusted gas to the outside.

The combustor 160 may be implemented as a flameless combustor. A flameless combustor oxidizes an object without creating a visible flame. A flameless combustor maintains a very high internal temperature, enabling combustion to occur naturally once the fuel reaches its ignition point. A flameless combustor is designed to ensure uniform mixing of fuel and oxidizer (air), preventing localized combustion and enabling stable combustion throughout the entire chamber. A flameless combustor is environmentally friendly, as it significantly reduces nitrogen oxide (NOx) emissions due to the absence of a visible flame. Furthermore, a flameless combustor enables even combustion, leading to efficient fuel usage, and the absence of a flame reduces the risk of explosion. A flameless combustor recirculates a portion of the exhaust gas back into the combustor, helping to maintain high temperatures and enhance combustion stability.

The controller 170 controls the overall operation of the solid oxide fuel cell system 100.

The controller 170 may control the flow paths of the fuel gas supplied from the fuel gas supply part 102 and air supplied from the air supply part 104 by means of the first directional valve V1 and the second directional valve V2.

The controller 170 controls the flow paths by means of the first directional valve V1 and the second directional valve V2 to increase the temperature inside the reformer 110, so that fuel gas and air may be supplied to the burner 115 through the first supply line L1 and the second supply line L2, respectively.

The controller 170 may operate the reformer 110 to generate reformed gas when the inside of the reformer 110 reaches a set temperature corresponding to the operating conditions of the reformer 110 by the burner 115.

During initial operation of the solid oxide fuel cell system 100, the controller 170 may control the burner 115 to combust fuel gas and air to quickly raise the temperature of the reformer 110 to a set temperature using the heat of combustion. As a result, the interior of the reformer 110 may quickly reach the appropriate operating conditions, enabling the rapid operation of the solid oxide fuel cell system 100.

The controller 170 may control the flow paths by the first directional valve V1 and the second directional valve V2 to generate reformed gas after the temperature inside the reformer 110 reaches a set temperature corresponding to the operating conditions of the reformer 110, so that fuel gas and air may be supplied to the reformer 110 through the first branch line L11 and the second branch line L12, respectively.

The controller 170 may open the on/off valve V4 so that air supplied from the air supply part 104 is supplied to the first heat exchanger 117 after the temperature inside the reformer 110 reaches a set temperature corresponding to the operating conditions of the reformer 110. Air heated by the first heat exchanger 117 may be supplied to the fuel cell stack 120 through the air electrode supply line L20.

The controller 170 may operate the fuel cell stack 120 when the fuel cell stack 120 reaches the set temperature corresponding to its operating conditions by the heated air supplied from the first heat exchanger 117.

The controller 170 can more quickly and efficiently heat the fuel cell stack 120 to the set temperature corresponding to its operating conditions by supplying air heated by the first heat exchanger 117 to the fuel cell stack 120.

This effectively addresses the long warm-up time required to reach the operating temperature during initial startup and improves the efficiency of energy use.

When the fuel cell stack 120 is operated, the controller 170 may supply reformed gas generated by the reformer 110 to the fuel cell stack 120 through the fuel electrode supply line L30. The controller 170 may control the flow path by means of the third directional valve V3 to supply the reformed gas to the fuel cell stack 120 or send the reformed gas to the combustor 160.

The controller 170 may control the flow path by means of the third directional valve V3 to send the reformed gas to the second heat exchanger 150 through the fuel electrode supply line L30 when at least one of the component and temperature of the reformed gas detected by the sensor part 140 meets the supply conditions for the fuel cell stack 120.

When at least one of the component and temperature of the reformed gas detected by the sensor part 140 does not meet the supply conditions for the fuel cell stack 120, the controller 170 may control the flow path by means of the third directional valve V3 to send the reformed gas toward the combustor 160 for combustion through the third branch line L13.

The controller 170 may implemented as a memory (not shown) that stores data for an algorithm for controlling the operation of each component of the solid oxide fuel cell system 100 or a program that reproduces the algorithm, and a processor (not shown) that performs the aforementioned operation using the data stored in the memory. In this case, the memory and the processor may be implemented as separate chips. Alternatively, the memory and the processor may be implemented as a single chip.

The storage part 180 may store data values measured by the sensor part 140. The storage part 180 may store various control operations, control signals, algorithms, setting values, etc., performed by the controller 170. The storage part 180 may be implemented as at least one of a non-volatile memory device such as a cache, a ROM (read-only memory), a PROM (programmable ROM), an EPROM (erasable programmable ROM), an EEPROM (electrically erasable programmable ROM), and a flash memory, a volatile memory device such as a RAM (random access memory), or a storage medium such as a hard disk drive (HDD) or a CD-ROM, but is not limited thereto.

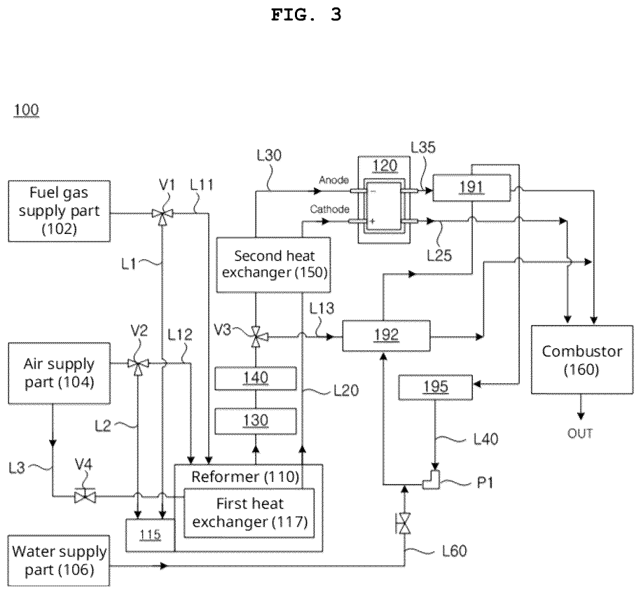

FIG. 3 shows another example of a configuration for heating water using unreacted excess reformed gas from a fuel cell stack and reformed gas that does not meet the supply conditions for the fuel cell stack in the solid oxide fuel cell system of FIG. 1.

Referring to FIG. 3, the solid oxide fuel cell system 100 may include: a water supply part 106 that supplies water; and a first circulation line L40 that circulates water supplied from the water supply part 106.

The water supply part 106 may supply water to the first circulation line L40 through a water supply line L60.

Seawater, a readily available resource onboard a ship, can be converted into fresh water through a desalination process and then stored in a storage tank (not shown).

The water supply part 106 may supply the aforementioned fresh water to the first circulation line L40.

In addition, the water supply part 106 may collect condensate generated during the air conditioning or heat exchange process onboard the ship and supply the collected condensate to the first circulation line L40.

The first circulation line L40 may be provided with a first heater 191, a first cooler 195, a first pump P1, and a second heater 192.

The first heater 191 heats up the water circulated in the first circulation line L40 via heat exchange with the unreacted excess reformed gas from the fuel cell stack 120.

The unreacted excess reformed gas from the fuel cell stack 120 may be discharged through the fuel electrode discharge line L35.

The excess reformed gas may be used to increase the temperature of water by exchanging heat with the water in the first heater 191 before being combusted by the combustor 160. That is, the first heater 191 refers to a heat exchanger, and heating is carried out using the excess reformed gas.

The first cooler 195 cools the water, whose temperature has increased by exchanging heat with the excess reformed gas in the first heater 191, to a set temperature.

At least a portion of the water cooled by the first cooler 195 may be supplied to the ship's air conditioning system and used to maintain the temperature inside the ship.

In addition, the water cooled by the first cooler 195 may be supplied to the ship's steam generator to generate steam for engine operation or other power sources.

The first pump P1 is installed in the first circulation line L40 to circulate water.

The second heater 192 heats up the water that has passed the first cooler 195 via heat exchange with the reformed gas, and then sends the heated water to the first heater 191.

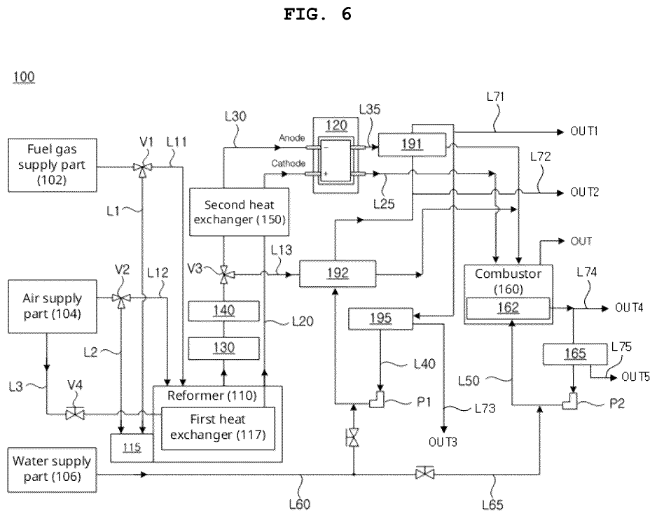

Meanwhile, FIG. 6 shows still another example of a configuration in which a water branch line is provided separately in the solid oxide fuel cell system of FIG. 1. Referring to FIG. 6, in the first circulation line L40, a separate water branch line is provided so that the user can divert water at the desired usage temperature.

The water heat-exchanged through the first heater 191 has a temperature close to the operating temperature of the fuel cell stack 120, making it the highest temperature and suitable for supply as heating water. Accordingly, a first water branch line L71 may be provided downstream of the first heater 191.

In addition, the first cooler 195 is capable of cooling water to temperatures such as hot, ambient (room temperature), or cold water, which can be used by the user. A second water line L72 for utilizing the water discharged after cooling may be provided downstream of the first cooler 195.

In the second heater 192, the reformed gas from the reformer 110 that does not meet the supply conditions exchanges heat with water. Accordingly, the water that has undergone heat exchange in the second heater 192 may have a lower temperature than that of the first heater. Thus, the water heat-exchanged through the second heater 192 may be used as heating water, and may either be joined with and discharged through the first water branch line L71 described above, or may be sent through a separate third water line L73 for use as heating water. Alternatively, the water may be supplied to the first cooler 195 and be used as general water (hot water, for example) after cooling. In other words, from the second heater 192, the water may be diverted to the first heater 191 line, either branching into the first water line L71, the third water line L73, or to the first cooler 195.

The reformed gas supplied to the fuel cell stack 120 through the fuel electrode supply line L30 is monitored by the sensor part 140. In case that one or more of the component and temperature of the reformed gas detected by the sensor part 140 do not satisfy the supply conditions required by the fuel cell stack 120, the controller 170 controls the flow path by means of the third directional valve V3 to send the reformed gas to the second heater 192 through the third branch line L13.

The second heater 192 transfers heat between the reformed gas and water circulated in the first circulation line L40. The reformed gas that has undergone heat exchange with water in the second heater 192 is sent toward the combustor 160 through the third branch line L13, and the water that has undergone heat exchange with the reformed gas is sent toward the first heater 191 through the first circulation line L40.

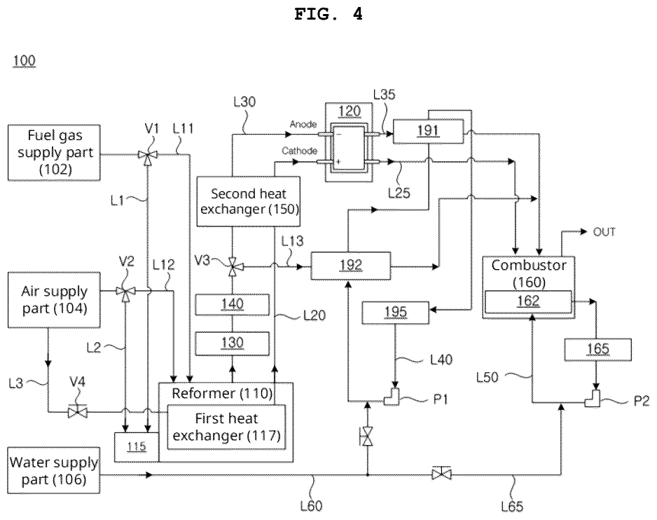

FIG. 4 shows still another example of a configuration for heating water using unreacted excess reformed gas and excess air from a fuel cell stack and heat generated from the combustion of reformed gas that does not meet the supply conditions for the fuel cell stack in the solid oxide fuel cell system of FIG. 1.

Referring to FIG. 4, the solid oxide fuel cell system 100 may include a second circulation line L50 that circulates water supplied from the water supply part 106.

The water supply part 106 may supply water to the second circulation line L50 through a water supply branch line L65 branched from the water supply line L60.

The second circulation line L50 may be provided with a third heater 162, a second cooler 165, and a second pump P2.

As described above, the combustor 160 may burn the mixture of unreacted excess reformed gas and excess air from the fuel cell stack 120, as well as reformed gas that does not meet the supply conditions for the fuel cell stack 120.

At this time, the unreacted reformed gas in the fuel cell stack 120 is discharged through the fuel electrode discharge line L35, and after exchanging heat with water in the first heater 191, is supplied to the combustor 160.

Unreacted excess air in the fuel cell stack 120 is discharged through the air electrode discharge line L25 and supplied to the combustor 160.

Reformed gas that does not meet the supply conditions for the fuel cell stack 120 is supplied to the combustor 160 after passing through the second heater 192 via the third branch line L13.

The third heater 162 may be included in the combustor 160, and heats the water circulating through the second circulation line L50 via heat exchange with the heat generated during combustion in the combustor 160.

The third heater 162 performs heat exchange between the high-temperature heat generated from the combustor 160 and the water circulating through the second circulation line L50. During this process, the water absorbs heat, resulting in an increase in its temperature.

In this way, by recovering the heat of combustion from the combustor 10 and heating the water, the energy efficiency of the entire system may be increased.

The second cooler 165 cools water, whose temperature has increased through heat exchange with the heat of combustion from the third heater 162, to a set temperature.

At least a portion of the water cooled by the second cooler 165 may be supplied to the ship's air conditioning system and used to maintain the temperature inside the ship.

In addition, water cooled by the second cooler 165 may be supplied to the ship's steam generator to produce steam for driving the engine or other power applications.

The second pump P2 is installed in the second circulation line L50 to circulate the water.

Meanwhile, as in the case of the first to third water branch lines L73 described above, the water may be discharged to the outside through a fourth water branch line L74 downstream of the third heater 162 and be used as general water, and may be discharged to the outside through a fifth water branch line L75 downstream of the second cooler 165.

In the case of the third heater 162, the water temperature is high because the third heater 162 performs heat exchange between the high-temperature heat generated from the combustor 160 and water, making the water suitable for use as heating water. Alternatively, the water may be cooled by the second cooler 165 to a lower temperature for use as general water (hot water, for example).

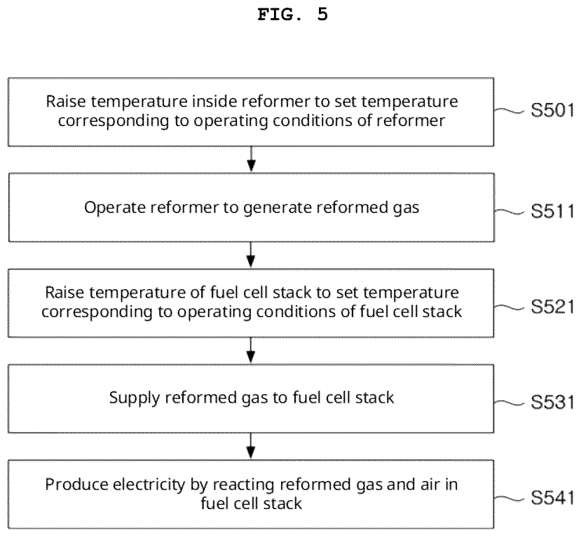

FIG. 5 is a flowchart showing the operation method of the solid oxide fuel cell system of FIG. 1. In FIG. 5, redundant content described above is omitted as much as possible.

Referring to FIG. 5, the controller 170 raises S501 the temperature inside the reformer to a set temperature corresponding to the operating conditions of the reformer 110 using the heat of combustion by supplying fuel gas and air to the burner for combustion.

The controller 170 may control the flow path by means of the first directional valve V1 and the second directional valve V2 to increase the temperature inside the reformer 110, so that fuel gas and air can be supplied to the burner 115 through the first supply line L1 and the second supply line L2, respectively.

Next, the controller 170 operates S511 the reformer 110 to generate reformed gas when the temperature inside of the reformer 110 reaches the set temperature corresponding to the operating conditions of the reformer 110.

In this case, once the temperature inside of the reformer 110 reaches the set temperature corresponding to the operating conditions of the reformer 110, the controller 170 may control the flow path by means of the first directional valve V1 and the second directional valve V2 to supply fuel gas and air to the reformer 110 through the first branch line L11 and the second branch line L12 to generate reformed gas.

Next, the controller 170 raises S521 the temperature of the fuel cell stack 120 to reach a set temperature corresponding to the operating conditions of the fuel cell stack 120 by supplying air heated by the first heat exchanger 117 to the fuel cell stack 120 through the air electrode supply line L20.

Once the temperature inside of the reformer 110 reaches the set temperature corresponding to the operating conditions of the reformer 110, the controller 170 opens the on/off valve V4 so that air is supplied from the air supply part 104 to the first heat exchanger 117, heated, and then supplied to the fuel cell stack 120 through the air electrode supply line L20.

Next, when the fuel cell stack 120 is operated, the controller 170 supplies S531 the reformed gas generated by the reformer 110 to the fuel cell stack 120 through the fuel electrode supply line L30.

In this case, in case that at least one of the component and temperature of the reformed gas detected by the sensor part 140 does not meet the supply conditions for the fuel cell stack 120, the controller 170 may control the flow path by means of the third directional valve V3 to send the reformed gas toward the combustor 160 for combustion through the third branch line L13.

The fuel cell stack 120 may produce S541 electricity by reacting reformed gas and air.

The unreacted excess reformed gas and excess air from the fuel cell stack 120 may be combusted by the combustor 160.

As described above, preferred embodiments of the present disclosure are illustrated and described with reference to the drawings, but the present disclosure is not limited to the specific embodiments described above. Various modifications may be made by a person with ordinary knowledge in the technical field to which the present disclosure pertains without departing from the gist of the present disclosure as claimed in the claims. These modifications should not be understood individually from the technical idea or perspective of the present disclosure.

What is claimed is:

1. A solid oxide fuel cell system, comprising:
a reformer configured to react fuel gas with air to generate reformed gas containing hydrogen;
a fuel cell stack configured to produce electricity by reacting the reformed gas with the air;
a water supply part configured to supply water;
a first circulation line configured to circulate water supplied from the water supply part;
a fuel electrode discharge line configured to discharge unreacted excess reformed gas from the fuel cell stack; and
a first heater provided in the first circulation line and configured to heat the water via heat exchange with the excess reformed gas to increase temperature of the water.

2. The system of claim 1, further comprising:
an air electrode discharge line configured to discharge unreacted excess air from the fuel cell stack; and
a combustor connected to the fuel electrode discharge line and the air electrode discharge line,
wherein the combustor burns a mixture of the excess reformed gas and excess air respectively discharged through the fuel electrode discharge line and the air electrode discharge line, and discharges resulting combustion gases to an outside.

3. The system of claim 2, further comprising:
a fuel electrode supply line configured to connect the reformer and a fuel electrode of the fuel cell stack and supply the reformed gas to the fuel electrode;
a second heater provided in the first circulation line, and configured to heat the water and then send the heated water to the first heater;
a third branch line branched from the fuel electrode supply line and configured to connect the second heater and the combustor;
a third directional valve provided at a branch point of the fuel electrode supply line;
sensor part configured to detect at least one of a component and temperature of the reformed gas; and
a controller configured to control a flow path by means of the third directional valve to send the reformed gas to the second heater through the third branch line so that the reformed gas exchanges heat with the water, and send the heat-exchanged reformed gas to the combustor for combustion, when at least one of the component and temperature of the reformed gas detected by the sensor part does not meet supply conditions for the fuel cell stack.

4. The system of claim 3, further comprising:
a second circulation line configured to circulate water supplied from the water supply part; and
a third heater provided in the second circulation line and configured to heat the water via heat exchange with heat generated during combustion in the combustor.
